(19) United States
(12) Patent Application Publication
(10) Pub. No.: US 2015/0378501 A1
(43) Pub. Date: Dec. 31, 2015

(54) TOUCH COMMUNICATIONS CONNECTION ESTABLISHING METHOD AND TOUCH PANEL DEVICE

(71) Applicant: MEDIATEK INC., Hsin-Chu (TW)

(72) Inventors: Hsiao-Wen Chen, New Taipei City (TW); Cheng-Wei Shih, Kaohsiung City (TW); Yung-Tso Chen, Taipei City (TW); Chia-Feng Yeh, Tainan City (TW)

(21) Appl. No.: 14/764,582

(22) PCT Filed: Dec. 30, 2014
(86) PCT No.: PCT/CN2014/095541

§ 371 Date: Jul. 30, 2015

Related U.S. Application Data
(60) Provisional application No. 61/921,645, filed on Dec. 30, 2013.

(51) Int. Cl. G06F 3/041; H04W 76/02; H04W 4/00

(52) U.S. Cl. CPC G06F 3/0416; H04W 4/008; H04W 76/02

(57) ABSTRACT

A touch communication connection establishing method, for establishing a touch communication between a first touch panel device (500) with a first touch panel (501) and a second touch panel device (900) with a second touch panel (901). The touch communication connection establishing method comprises: sensing at least one control action, wherein the control action comprises at least one touch communication related action, and/or determining if an arrangement of the control action meets a predetermined rule to generate a determining result; and establishing the touch communication connection between the first touch panel device (500) and the second touch panel device (900) based on the determining result.

### CROSS REFERENCE TO RELATED APPLICATIONS

This application claims the benefit of U.S. Provisional Application No. 61/921,645, filed on Dec. 30, 2013, the contents of which are incorporated herein by reference.

### TECHNICAL FIELD

The present application relates to a touch communications connection establishing method and a touch panel device, and particularly relates to a touch communications connection establishing method and a touch panel device that can establish a touch communications connection via simple steps.

### BACKGROUND

According to the related art, Near Field Communication (NFC) can be regarded as a contactless identification and interaction technology, and can be used for performing short distance wireless communications between mobile devices, consumer electronic products, personal computers, and/or intelligent electronic devices through a method of near field magnetic coupling (e.g. using the frequency of 13. 56 MHz). The users of NFC devices can intuitively exchange information and acquire contents and services with ease.

As the market for portable electronic devices such as mobile phones equipped with NFC functionalities has become mature, they can be used for supporting mobile payment or point of sale (POS). However, as the NFC devices are designed to transmit and receive signals through magnetic coupling, it is typical to implement an inductive card reader or some components having similar functionalities in the aforementioned portable electronic devices such as the mobile phones mentioned above, which may cause the sizes of the portable electronic devices to be increased, and further cause the layouts, the structure arrangement, and the materials of components in the portable electronic devices such as the mobile phones to be limited.

Therefore, some touch communications technologies regarding touch panel devices (e.g. electronic device equipped with touch panels), such as those described in the U.S. Patent Application Publication No. 2011/0304583, the U.S. Patent Application Publication No. US 2013/0147760, the China Patent Application Publication No. CN 102916729 A, are proposed recently, where the touch panels and the driving integrated circuit (IC) in the touch panel devices can be used for performing communications and data transmission. For example, a conventional touch panel device may comprise a touch sensor. In addition, at least one portion of the touch sensor can be at least one portion of the touch panel in the conventional touch panel device, where the touch panel can be a touch panel that does not have the display functionality (e.g. a touch pad), or a touch panel that has the display functionality (e.g. a touch screen). The touch sensor may comprise multiple driving electrodes and sensing electrodes installed on substrates, such as the driving electrodes and the sensing electrodes for forming capacitor structures. At least one of the driving electrodes and the sensing electrodes can be used as transmitting electrodes, and at least one of the driving electrodes and the sensing electrodes can be used as receiving electrodes. Thus, the signals can be transmitted or received by using the electrodes and the driving IC in the conventional touch panel device, to realize touch communications based on electric fields, having no need to implement any inductive card reader or some components having similar functionalities in the conventional touch panel device, where this architecture can significantly reduce the size and save the costs, in comparison with the NFC technology.

Please refer to FIG. 1, which illustrates a diagram of touch communications between a first touch panel device 101 and a second touch panel device 102 according to the related art. As shown in FIG. 1, there are near field electric fields 103a and 103b between the first touch panel device 101 and the second touch panel device 102. It should be noted that each of the first touch panel device 101 and the second touch panel device 102 can have the functionalities of transmitting and receiving signals.

Based on this touch communications technology, when the first touch panel device 101 transmits signals toward the second touch panel device 102, the communications medium used by the first touch panel device 101 is the electric field portion whose electric field direction is pointing toward the second touch panel device 102 (e.g. the near electric field 103a shown in FIG. 1). In addition, when the second touch panel device 102 transmits signals toward the first touch panel device 101, the communications medium used by the second touch panel device 102 is the electric field portion whose electric field direction is pointing toward the first touch panel device 101 (e.g. the near electric field 103b shown in FIG. 1). Please note that the X channels and the Y channels shown in FIG. 1 may represent the transmitting electrodes and receiving electrodes installed on substrates, such as the transmitting electrodes and the receiving electrodes for forming capacitor structures.

FIG. 2 is a logical block diagram of a touch communications system for realizing the touch communications between the first touch panel device 101 and the second touch panel device 102 shown in FIG. 1 according to the related art, where the touch communications system may comprise a signal transmitting system 201 and a signal receiving system 202. The first touch panel device 101 shown in FIG. 1 may comprise the signal transmitting system 201 shown in FIG. 2, and the second touch panel device 102 shown in FIG. 1 may comprise the signal receiving system 202 shown in FIG. 2. The signal transmitting system 201 may comprise a touch communications request signal generating unit 211, a communications connection establishment unit 212, and a first communications unit 213. More particularly, the touch communications request signal generating unit 211 may be arranged to generate a touch communications request signal, and to transmit the touch communications request signal to the second touch panel device 102 through the transmitting electrodes of the first touch panel device 101. After the first touch panel device 101 receives a response signal responded by the second touch panel device 102, such as the response signal received through the receiving electrodes of the first touch panel device 101, the communications connection establishment unit 212 may establish a communications connection with the second touch panel device 102 (i.e. the communications connection between the first touch panel device 101 and the second touch panel device 102). After the communications connection establishment unit 212 establishes the communications connection, the first communications unit 213 may transmit communications information and/or data to the second touch panel device 102 through the transmitting electrodes of the first touch panel device 101.

The signal receiving system 202 may comprise a touch communications request signal responding unit 221, a communications connection establishment unit 222, and a second communications unit 223. More particularly, after receiving the touch communications request signal transmitted by the first touch panel device 101, such as the touch communications request signal received through the receiving electrodes of the second touch panel device 102, the touch communications request signal responding unit 221 may respond to the touch communications request signal with a response signal such as that mentioned above, and more particularly, may send the response signal to the first touch panel device 101 through the transmitting electrodes of the second touch panel device 102. After the touch communications request signal responding unit 221 responds to the touch communications request signal of the first touch panel device 101 with the response signal, the communications connection establishment unit 222 may establish the communications connection with the first touch panel device 101 (i.e. the communications connection between the first touch panel device 101 and the second touch panel device 102). After the communications connection establishment unit 222 establishes the communications connection, the second communications unit 223 may receive the communications information and/or data from the first touch panel device 101 through the receiving electrodes of the second touch panel device 102.

FIG. 3 illustrates a first touch panel 301 of the first touch panel device 101 shown in FIG. 1 and a second touch panel 302 of the second touch panel device 102 shown in FIG. 1 according to the related art. As shown in FIG. 3, each touch panel of the first touch panel 301 and the second touch panel 302 may comprise a touch sensor (not completely shown in FIG. 3). For example, the touch sensor of the first touch panel 301 may comprise a set of transmitting electrodes installed on at least one substrate of the first touch panel 301 (e.g. the transmitting electrode 311) for transmitting signals, and may comprise a set of receiving electrodes installed on at least one substrate of the first touch panel 301 (e.g. the receiving electrode 312) for receiving signals. In another example, the touch sensor of the second touch panel 302 may comprise a set of transmitting electrodes installed on at least one substrate of the second touch panel 302 (e.g. the transmitting electrode 321) for transmitting signals, and may comprise a set of receiving electrodes installed on at least one substrate of the second touch panel 302 (e.g. the receiving electrode 322) for receiving signals.

FIG. 4 is a flowchart of a touch communications method according to the related art. First, in Step S401, the touch communications request signal generating unit 211 of the first touch panel device 101 may generate a touch communications request signal such as that mentioned above, and transmit the touch communications request signal to the second touch panel device 102 through the transmitting electrode(s) of the first touch panel device 101. Afterward, in Step S402, the touch communications request signal responding unit 221 of the second touch panel device 102 may respond to the touch communications request signal with a response signal such as that mentioned above through the transmitting electrode(s) of the second touch panel device 102, and more particularly, send the response signal to the first touch panel device 101 through the transmitting electrode(s) of the second touch panel device 102. After the first touch panel device 101 receives the response signal responded by the second touch panel device 102, such as the response signal received through the receiving electrodes of the first touch panel device 101, in Step S403, the communications connection establishment unit 212 of the first touch panel device 101 and the communications connection establishment unit 222 of the second touch panel device 102 may establish a communications connection such as that mentioned above (i.e. the communications connection between the first touch panel device 101 and the second touch panel device 102). As a result, in Step S404, the first touch panel device 101 (more particularly, the first communications unit 213 therein) and the second touch panel device 102 (more particularly, the second communications unit 223 therein) may perform communications as shown in FIG. 4. For example, the first communications unit 213 of the first touch panel device 101 may transmit the communications information and/or data to the second touch panel device 102 through the transmitting electrodes of the first touch panel device 101, and the second communications unit 223 of the second touch panel device 102 may receive the communications information and/or data from the first touch panel device 101 through the receiving electrodes of the second touch panel device 102.

However, if a user wants to establish a touch communications connection between two touch panel devices, various steps are needed. For example, the user may need to turn on the display of the touch panel device, find the icon for establishing the touch communications connection to command the touch panel device. Or, the user may need to press a button provided on the touch panel devices to establish the touch communications connection, thereby the button is easily broken if it is pressed too frequently.

### SUMMARY

Therefore, one objective of the present application is to provide a touch communications connection establishing method and a touch panel device that can establish a touch communications connection via simple step(s).

Another objective of the present application is to provide a touch communications connection establishing method and a touch panel device that can reduce power consumption for establishing a touch communications connection.

Still another objective of the present application is to provide a touch communications connection establishing method and a touch panel device that can establish a touch communications connection without pressing or touching a button.

One exemplary embodiment of the present application discloses a touch communications connection establishing method, for establishing a touch communications connection between a first touch panel device with a first touch panel and a second touch panel device with a second touch panel. The touch communications connection establishing method comprises: sensing at least one control action, wherein the control action comprises at least one touch communications related action, and/or determining if an arrangement of the control action meets a predetermined rule to generate a determining result; and establishing the touch communications connection between the first touch panel device and the second touch panel device based on the determining result.

Another exemplary embodiment of the present application discloses a touch panel device, which can establish a touch communications connection between the touch panel device and another touch panel device with a second touch panel. The touch panel device comprises: a first touch panel; and a control module, capable of sensing at least one control action and/or determining if an arrangement of the control action meets a predetermined rule to generate a determining result, wherein the control action comprises at least one touch communications related action; wherein the control module is further capable of establishing the touch communications connection between the touch panel device and the another touch panel device based on the determining result.

In view of above-mentioned exemplary embodiments, the touch communications connection can be established via simple steps. Additionally, the control action(s) to trigger the touch communications connection establishing can be performed when the touch panel device is in a sleep mode, or in a situation that the display of the touch panel device is turned off, such that the power consumption can be decreased.

Furthermore, the control action(s) to trigger the touch communications connection establishing can be performed without a button on the touch panel device, thus the button on the touch panel device may be more durable.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of touch communications between a first touch panel device and a second touch panel device according to the related art.

FIG. 2 is a logical block diagram of a touch communications system for realizing the touch communications between the first touch panel device and the second touch panel device shown in FIG. 1 according to the related art.

FIG. 3 illustrates a first touch panel of the first touch panel device shown in FIG. 1 and a second touch panel of the second touch panel device shown in FIG. 1 according to the related art.

FIG. 4 is a flowchart of a touch communications method according to the related art.

FIG. 5 is a block diagram illustrating a touch panel device according to one exemplary embodiment of the present application.

FIG. 6 is a schematic diagram illustrating the operation for a touch communications connection establishing method according to one exemplary embodiment of the present application.

FIG. 7-FIG. 9 are schematic diagrams illustrating examples of the control action.

FIG. 10 is a flow chart illustrating a touch communications connection establishing method according to one exemplary embodiment of the present application.

### DETAILED DESCRIPTION

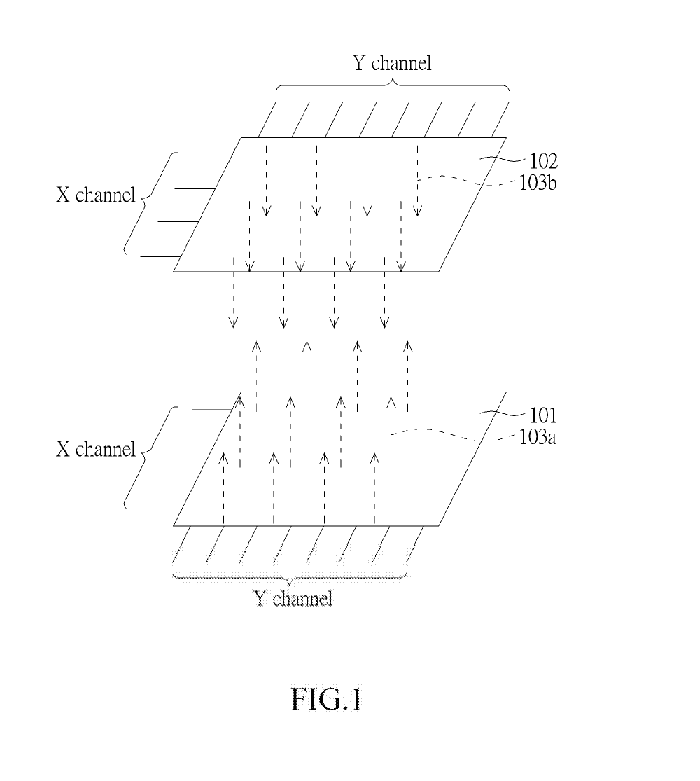

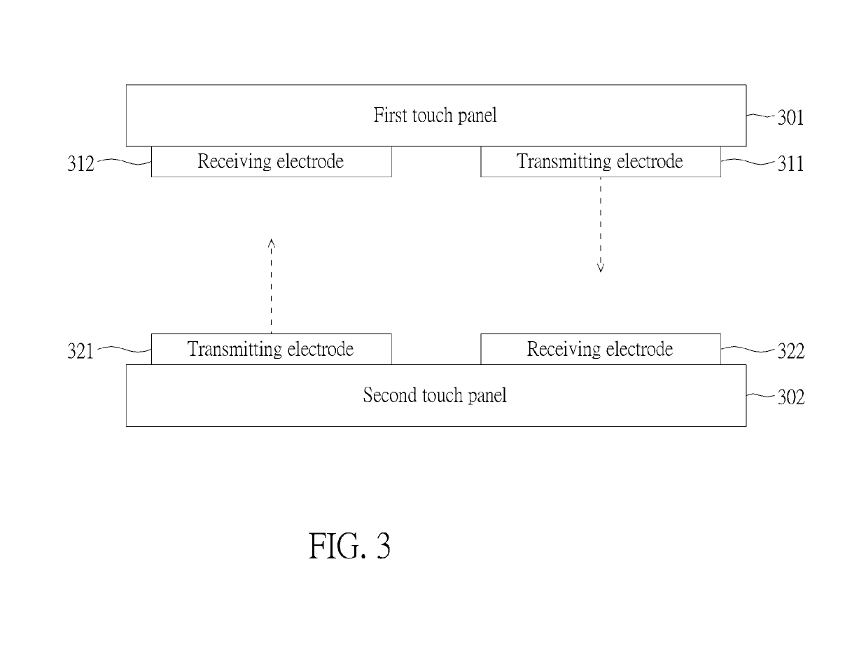

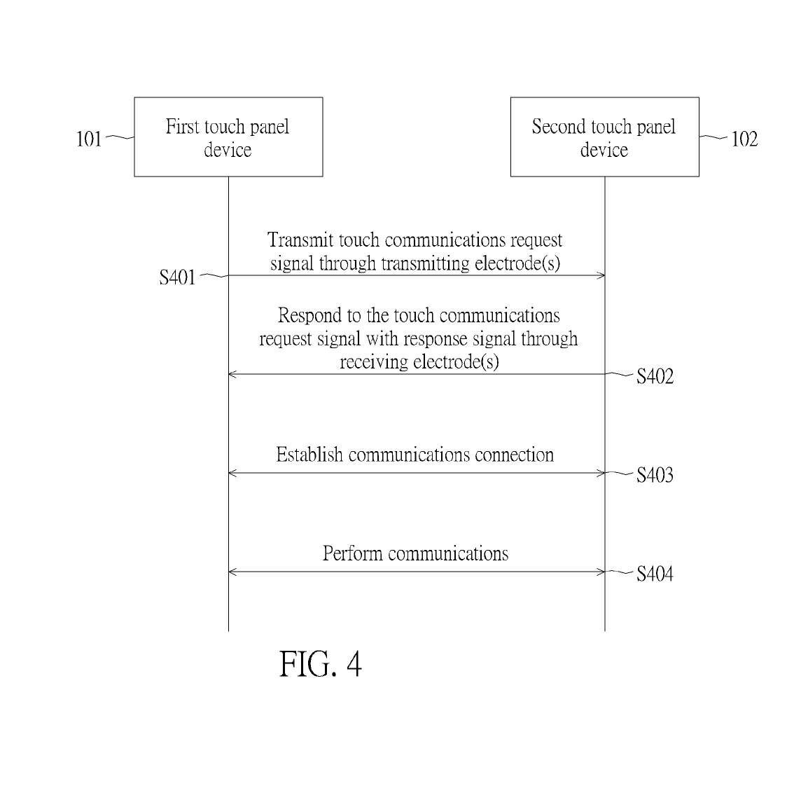

Some exemplary embodiments are provided as below to explain the concept of the present application. In the following exemplary embodiments, the operations illustrated in FIG. 1-FIG. 4 can be applied while establishing a touch communications connection. However, it will be appreciated that the touch communications connection can be established via other operations.

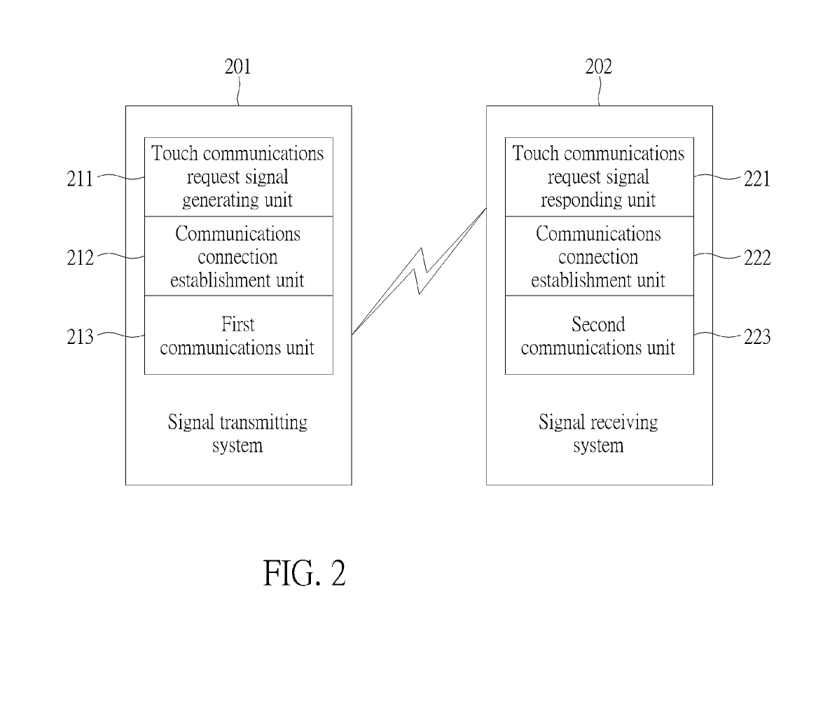

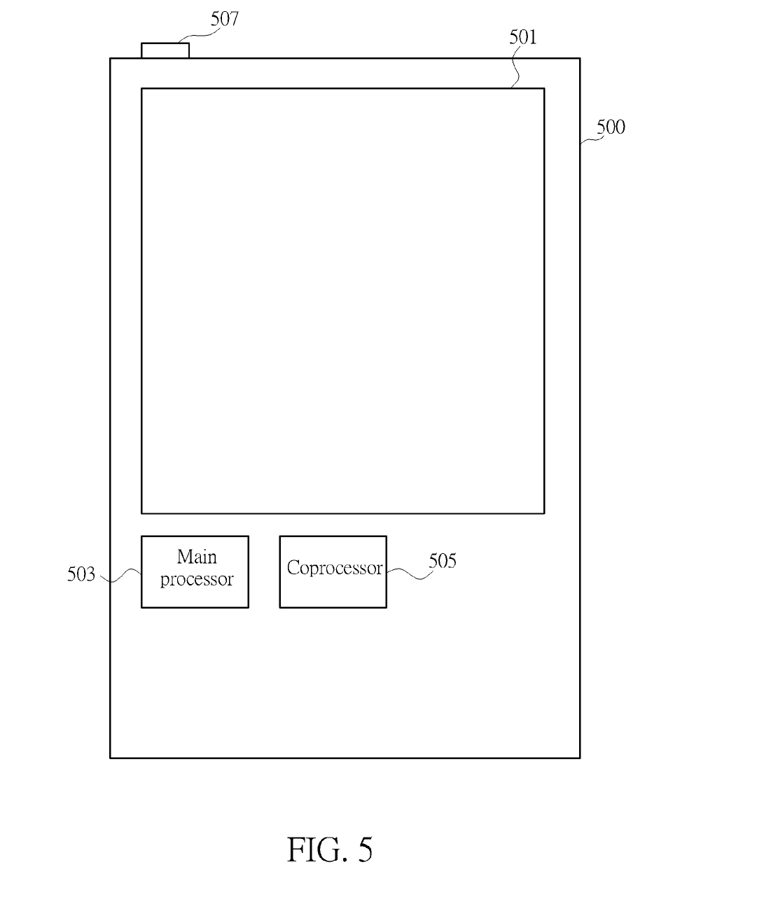

FIG. 5 is a block diagram illustrating a touch panel device according to one exemplary embodiment of the present application. As shown in FIG. 5, the touch panel device 500 may include a touch panel 501, a main processor 503, and a coprocessor 505. The main processor 503 can perform the operation of the signal transmitting system 201 and/or the signal receiving system 202 illustrated in FIG. 2, and can control the transmitting and/or receiving of data and/or information. The data and/or information can be transmitted and/or received via touch communications connection. Alternatively, the main processor 503 may sense the control action which will be described later. The function of the coprocessor 505 will also be described later. Please note some detail structures for the touch panel device 500, for example, the transmitting electrodes 311, 321 and the receiving electrodes 312, 322, are omitted for brevity here.

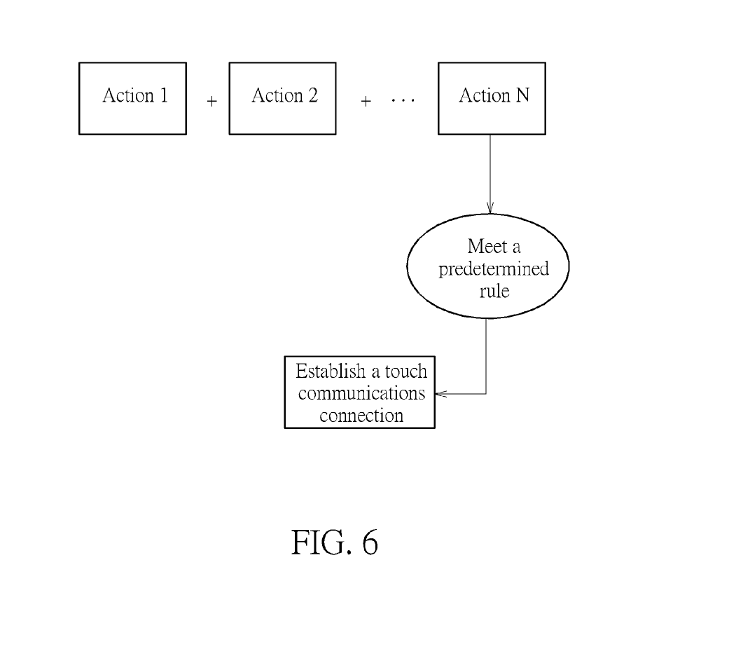

FIG. 6 is a schematic diagram illustrating the operations for a touch communications connection establishing method according to one exemplary embodiment of the present application. As shown in FIG. 6, the touch communications connection establishing method may include: sensing at least one control action (Action 1, Action 2 . . . Action N). The control action(s) can be performed via a first touch panel device (ex. 500 in FIG. 5), to the first touch panel device, via a second touch panel device, to the second touch panel device or a combination thereof. The control action(s) (Action 1, Action 2 . . . Action N) may include at least one touch communications related action. The touch communications related action can be designed to facilitate establishing the touch communications connection. In one exemplary embodiment, the touch communications related action may be an action facilitating and/or using touch communications.

For example, the touch communications related action may be moving the touch panel device 500 and/or another touch panel device thereby a distance between the touch panel device 500 and the other touch panel device is not larger than a predetermined distance value. In one example, the predetermined distance value may be 2 cm. However, the predetermined distance value may vary with the touch panel, its driving IC, and the design of the touch panel device, etc. and may be greater, such as 5 cm, or may be less, such as 2 mm, and so on.

In another example, the touch communications related action may be moving the touch panel device 500 and/or another touch panel device thereby an overlapping area of the touch panel 501 and the touch panel of the other touch panel device is not smaller than a predetermined area value. For example, the predetermined area value can be 10 cm², which may vary with the touch panel, its driving IC, and the design of the touch panel device, etc. and may be greater, such as 20 cm², or may be less, such as 5 cm², and so on. In another example, the predetermined area value can be proportional to an area of the touch panel 501 or an area of the touch panel of the other touch panel device. For example, the predetermined area value may be ½ of the area of the touch panel 501 or ⅔ of the area of the touch panel of the other touch panel device, which may vary with the touch panel, its driving IC, and the design of the touch panel device, etc.

The control action(s) may also include at least one gesture via the touch panel device 500, to the touch panel device 500, to another touch panel device or a combination thereof. Please note the at least one control action (Action 1, Action 2 . . . Action N) can include only one control action. In such case, the control action may be a touch communications related action. Also, if the number of the at least one control action is more than one, the control actions can be continuously performed. Then performing at least one control action via the touch panel device 500 can be performing a plurality of continuous control actions via the touch panel device 500, performing at least one control action via another touch panel device can be performing a plurality of continuous control actions via the other touch panel device and so on. In one exemplary embodiment, if the time period(s) between the control actions being performed is/are not larger than a predetermined value, the control actions may be regarded as continuously performed.

It should be noted that the at least one control action can be sensed by either one or more components of the touch panel device 500 or one or more components of another touch panel device, no matter the control action(s) is/are performed to/via the touch panel device 500 or the other touch panel device. If the control action(s) is/are sensed by the touch panel device 500, the sensing result can be kept for one or more component of the touch panel device 500 to use or sent to the other touch panel device. If the control action(s) is/are sensed by the other touch panel device, the sensing result can be kept for one or more component of the other touch panel device to use or sent to the touch panel device 500. During or after the control action(s) is/are performed, a component of the touch panel device 500 such as the main processor 503 and/or a component of another touch panel device such as a processor of the other touch panel device may determine if an arrangement of the control action(s) meets a predetermined rule to generate a determining result. The determining result generated by one touch panel device can be sent to another touch panel device and vice versa. If the arrangement of the control action(s) meets a predetermined rule, a touch communications connection can be established between the touch panel device 500 and another touch panel device based on the determining result.

The touch communications connection can be established with aid of the touch panel 501 and/or the touch panel of the other touch panel device. In one exemplary embodiment, the predetermined rule may include at least one predetermined gesture and at least one predetermined touch communications related action. For example, the predetermined gesture may be drawing a circle, an alphabet or any other pattern via the touch panel device 500, to the touch panel device 500, via the other touch panel device, to the other touch panel device or a combination thereof. In another exemplary embodiment, the predetermined rule may include only at least one predetermined touch communications related action, then the touch communications connection between the touch panel device 500 and another touch panel device may be established based on the touch communications related action(s) included in the at least one control action. Besides, the predetermined rule may include or not include the sequence that the control action(s) is/are performed. For example, the predetermined rule may require Action 2 to be performed after Action 1; while in another example, either Action 2 is performed before or after Action 1 meets the predetermined rule. The examples of predetermined rule mentioned above are for illustrative purpose only, but not for limitation. Any predetermined rule including at least one action can help determine whether and/or how to establish the touch communications connection between the touch panel device 500 and another touch panel device.

After the touch communications connection has been established, data and/or information can be transmitted unidirectionally or bidirectionally between the touch panel devices. For more detail, unidirectionally may indicate data and/or information is transmitted only from the touch panel device 500 to another touch panel device, or transmitted only from another touch panel device to the touch panel device 500, and bidirectionally may indicate data and/or information can be transmitted between the touch panel device 500 and the another touch panel device. Touch communication connection establishment and data/information transmission can be triggered by the same or different control action(s). For example, in one case, once the arrangement of the control action(s) meets a predetermined rule, the touch communication connection is established between two touch panel devices and data/information is transmitted. In another case, once the arrangement of first control action(s) meets a predetermined rule, the touch communication connection is established between two touch panel devices; and then if the arrangement of second control action(s) meets a predetermined rule, data/information is transmitted.

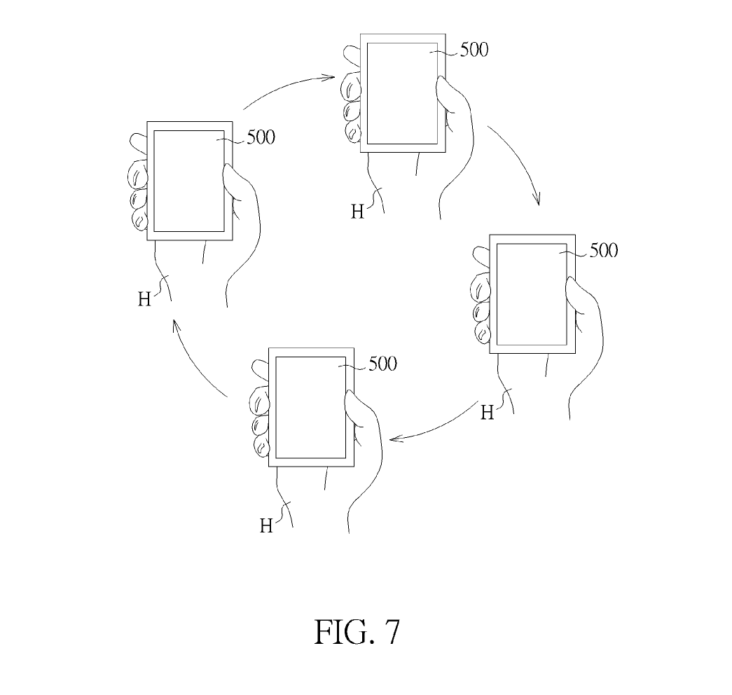

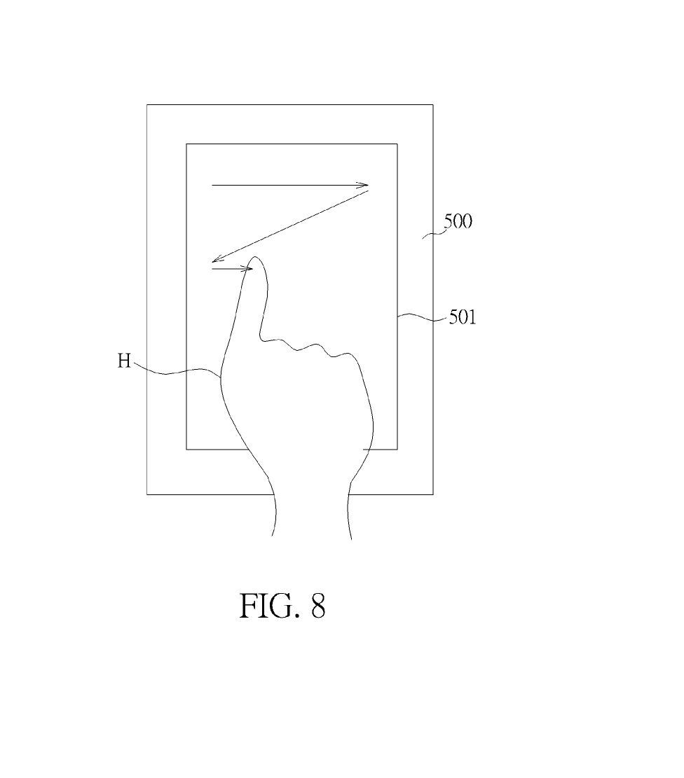

FIG. 7-FIG. 9 are schematic diagrams illustrating examples of the control action(s). As shown in FIG. 7, an exemplary control action is holding the touch panel device 500 via a hand H and drawing a circle via moving the touch panel device 500 (i.e. performing a gesture via the touch panel device 500). For sensing the control action illustrated in FIG. 7, a gravity sensor can be further included in the touch panel device 500. Another exemplary control action can be performing at least one gesture via the hand H to the touch panel 501 of the touch panel device 500, such as drawing the alphabet Z as shown in FIG. 8.

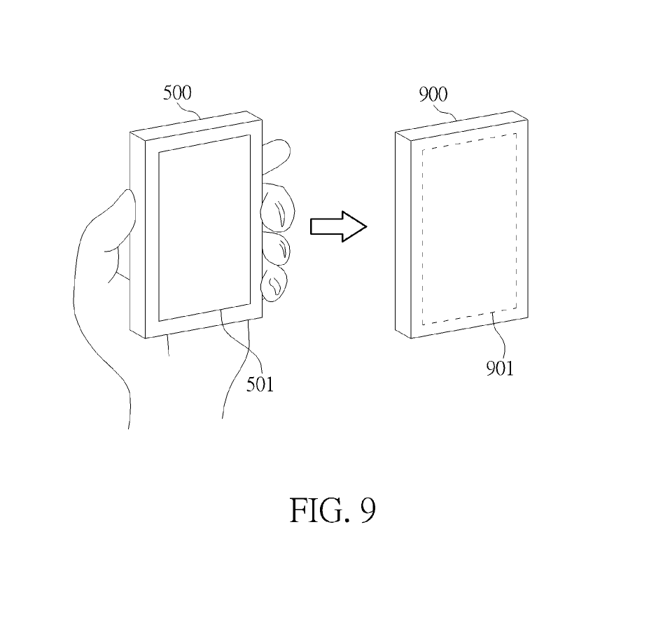

FIG. 9 illustrates another exemplary control action, which can be a touch communications related action. In one exemplary embodiment, the touch panel device 500 can be moved, for example, toward the touch panel device 900 as shown in FIG. 9 and/or the touch panel device 900 can be moved, for example, toward the touch panel device 500, thereby the touch panel device 500 is close to or in contact with the touch panel device 900. In one example, a distance between the touch panel device 500 and the touch panel device 900 is not larger than a predetermined distance value (ex. 3 cm) can be regarded as that the touch panel device 500 is close to or in contact with the touch panel device 900.

A proximity sensor can be further included in the touch panel device 500 and/or the touch panel device 900 to sense if the touch panel device 500 is close to or in contact with the touch panel device 900. In another example, the touch panel device 500 and/or the touch panel device 900 can be moved thereby an overlapping area of the touch panel 501 and the touch panel 901 is not smaller than a predetermined area value. For example, the predetermined area value can be 10 cm², ⅔ of the area of the touch panel 501, or ½ of the area of the touch panel 901. Whether the overlapping area of the touch panel 501 and the touch panel 901 is smaller than a predetermined area value or not can be sensed with aid of the touch panel 501 and/or the touch panel 901.

During or after the control action(s) is/are performed, the arrangement of the control action(s) can be determined if meeting a predetermined rule and a determining result can be generated. Therefore the touch communications connection between the touch panel device 500 and the touch panel device 900 can be established based on the determining result. However, please note the number and the arrangement are not limited to the examples illustrated in FIG. 7-FIG. 9.

In one exemplary embodiment, the control action(s) is/are performed when the touch panel device 500 is in a sleep mode, which means one or more components (ex. display) of the touch panel device 500, may be inactive. In one exemplary embodiment, the touch panel device 500 may include a coprocessor 505, as shown in FIG. 5. In the sleep mode, the main processor 503 may be inactive, and the coprocessor 505 may be active to receive or sense the control action(s).

The touch panel device 500 may include a display, which can be integrated into the touch panel to form a touch screen or independent from the touch panel. In one exemplary embodiment, the control action(s) is performed without turning on the display.

In still another exemplary embodiment, the first touch panel device may include at least one button (ex. button 507 in FIG. 5) provided thereon, and the control action may not include pressing or touching the button.

A touch panel device applying the above-mentioned exemplary embodiments can be summarized as: a touch panel device, which can establish a touch communications connection between the touch panel device (ex. 500) and another touch panel device (ex. 900) with a second touch panel (ex. 901), comprising: a first touch panel (ex. 501); and a control module, for sensing at least one control action and/or determining if an arrangement of the control action meets a predetermined rule to generate a determining result, wherein the control action comprises at least one touch communications related action. The control module can comprise only the main processor 503 or both the main processor 503 and the coprocessor 505. The control module can further comprise other sensors, such as the above-mentioned gravity sensor and proximity sensor. The control module can establish the touch communications connection between the touch panel device and the other touch panel device based on the determining result.

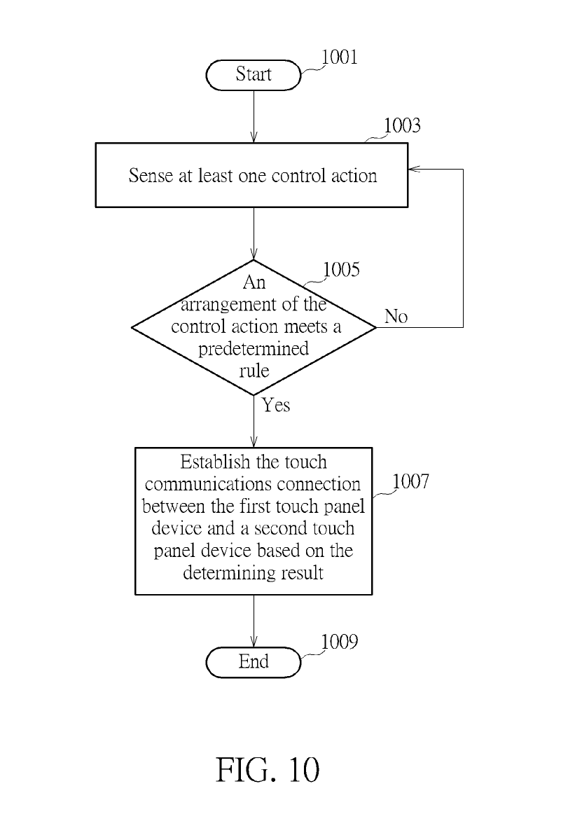

In view of abovementioned exemplary embodiments, a touch communications connection establishing method according to one exemplary embodiment of the present application can be acquired. FIG. 10 is a flow chart illustrating a touch communications connection establishing method according to one exemplary embodiment of the present application.

Step 1001, Start.

Step 1003, Sense at least one control action. The control action can be performed via a first touch panel device (ex. touch panel device 500), to the first touch panel device, via a second touch panel device (ex. touch panel device 900), to the second touch panel device or a combination thereof. The control action(s) may include at least one touch communications related action.

Step 1005, Determine if an arrangement of the control action meets a predetermined rule to generate a determining result. If not, go back to the step 1003, if yes, go to step 1007.

Step 1007, Establish the touch communications connection between the first touch panel device and a second touch panel device based on the determining result. In one example, the touch communications connection between the first touch panel device and the second touch panel device is established based on the touch communications related action, if an arrangement for the control action meets the predetermined rule.

Step 1009, End.

Please note that the steps shown in FIG. 10 can be performed in different orders and one or more steps can be omitted or added. For example, steps 1003 and/or step 1005 can be performed by another touch panel device and thus omitted.

In view of above-mentioned exemplary embodiments, the touch communications connection can be established via simple step(s). Additionally, the control actions to trigger the touch communications connection establishing can be performed when the touch panel device is in a sleep mode, or in a situation that the display of the touch panel device is turned off, such that the power consumption can be decreased. Furthermore, the control actions to trigger the touch communications connection establishing can be performed without a button on the touch panel device, thus the button on the touch panel device may be more durable.

Those skilled in the art will readily observe that numerous modifications and alterations of the device and method may be made while retaining the teachings of the invention. Accordingly, the above disclosure should be construed as limited only by the metes and bounds of the appended claims.

1. A touch communications connection establishing method, for establishing a touch communications connection between a first touch panel device with a first touch panel and a second touch panel device with a second touch panel, comprising:
sensing at least one control action, wherein the control action comprises at least one touch communications related action, and/or determining if an arrangement of the control action meets a predetermined rule to generate a determining result; and
establishing the touch communications connection between the first touch panel device and the second touch panel device based on the determining result.

2. The touch communications connection establishing method of claim 1, wherein the control action comprises:
at least one gesture via the first touch panel device, to the first touch panel device, via the second touch panel device, to the second touch panel device or a combination thereof.

3. The touch communications connection establishing method of claim 1, wherein the control action comprises a plurality of continuous control actions.

4. The touch communications connection establishing method of claim 1, wherein the step of determining if the arrangement of the control action meets the predetermined rule to generate the determining result is performed by a processor of the first touch panel device and/or a processor of the second touch panel device.

5. The touch communications connection establishing method of claim 1, wherein the first touch panel device comprises at least one button provided thereon, wherein the control action does not comprise pressing or touching the button.

6. The touch communications connection establishing method of claim 1, wherein the first touch panel comprises a display, wherein the control action is performed without turning on the display.

7. The touch communications connection establishing method of claim 1, wherein the control action is performed when the first touch panel device is in a sleep mode.

8. The touch communications connection establishing method of claim 7, wherein the first touch panel device comprises a main processor and a coprocessor, wherein the main processor is inactive in the sleep mode, and the coprocessor is active for sensing the control action in the sleep mode.

9. The touch communications connection establishing method of claim 1, wherein the touch communications related action comprises:
moving the first touch panel device and/or the second touch panel device thereby a distance between the first touch panel device and the second touch panel device is not larger than a predetermined distance value.

10. The touch communications connection establishing method of claim 9, wherein the touch communications related action further comprises moving the first touch panel device and/or the second touch panel device thereby an overlapping area of the first touch panel and the second touch panel is not smaller than a predetermined area value.

11. The touch communications connection establishing method of claim 1, wherein the touch communications related action is an action facilitating and/or using touch communications.

12. A touch panel device, which can establish a touch communications connection between the touch panel device and another touch panel device with a second touch panel, comprising:
a first touch panel; and
a control module capable of sensing at least one control action and/or determining if an arrangement of the control action meets a predetermined rule to generate a determining result, wherein the control action comprises at least one touch communications related action;
wherein the control module is further capable of establishing the touch communications connection between the touch panel device and the another touch panel device based on the determining result.

13. The touch panel device of claim 12, wherein the control action comprises:
at least one gesture via the first touch panel device, to the first touch panel device, via the second touch panel device, to the second touch panel device or a combination thereof.

14. The touch panel device of claim 12, wherein the control action comprises a plurality of continuous control actions.

15. The touch panel device of claim 12, wherein the control module comprises a processor, the another touch panel device comprises a processor, wherein the step of determining if the arrangement of the control action meets the predetermined rule to generate the determining result is performed by the processor of the control module and/or the processor of the another touch panel device.

16. The touch panel device of claim 12, wherein the touch panel device comprises at least one button provided thereon, wherein the control action does not comprise pressing or touching the button.

17. The touch panel device of claim 12, wherein the touch panel device comprises a display, wherein the control action is performed without turning on the display.

18. The touch panel device of claim 12, wherein the touch communications related action comprises:
moving the touch panel device and/or the another touch panel device thereby a distance between the touch panel device and the another touch panel device is not larger than a predetermined distance value.

19. The touch panel device of claim 12, wherein the touch communications related action further comprises moving the touch panel device and/or the another touch panel device thereby an overlapping area of the first touch panel and the second touch panel is not smaller than a predetermined area value.

20. The touch panel device of claim 12, wherein the touch communications related action is an action facilitating and/or using touch communications.
